(19) United States
(12) Patent Application Publication
(10) Pub. No.: US 2009/0004381 A1
(43) Pub. Date: Jan. 1, 2009

(54) THREE-DIMENSIONAL MOLDING APPARATUS AND THREE-DIMENSIONAL MOLDING METHOD

(75) Inventors: Kazutoshi FUJISAWA, Okaya-shi (JP); Toshio KUMAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/147,321

(22) Filed: Jun. 26, 2008

(30) Foreign Application Priority Data
Jun. 27, 2007 (JP) 2007-168608

(51) Int. Cl. B05D 1/38

(52) U.S. Cl. 427/203; 425/375

(57) ABSTRACT

A three-dimensional molding apparatus for binding powder with a binding liquid to mold a three-dimensional object. When the three-dimensional object is cut into cross-sectional layers, a cross-section data generating unit generates cross-section data for each of the layers. A cross-sectional member forming unit spreads the powder so as to have a substantially uniform thickness to form a powder layer and supplies the binding liquid to the powder layer on the basis of the cross-section data to form a cross-sectional member corresponding to one layer of the three-dimensional object. A three-dimensional object molding unit forms a new powder layer on the powder layer in which the cross-sectional member is formed, supplies the binding liquid to the new powder layer on the basis of the cross-section data to form a new cross-sectional member, and laminates the new cross-sectional member on the previous cross-sectional member, thereby forming the three-dimensional object.

### BACKGROUND

1. Technical Field

The present invention relates to a technique for molding a three-dimensional object, and more particularly, to a technique for discharging a binding liquid to bind powder particles, thereby allowing molding of a three-dimensional object.

A technique for binding powder with a binding liquid to mold a three-dimensional object has been proposed. In this technique, the following processes are repeated to mold a three-dimensional object. First, powder is spread with a uniform thickness to form a powder layer, and a binding liquid is discharged to a desired portion of the powder layer to bind powder particles. As a result, the powder particles in only the portion of the powder layer to which the binding liquid is discharged are bound to each other, and a thin plate member is formed. In the specification, such a thin plate member is referred to as a ‘cross-sectional member’. Then, another thin powder layer is formed on the powder layer, and the binding liquid is discharged to a desired portion of the powder layer. As a result, a new cross-sectional member is formed in the portion of the powder layer to which the binding liquid is discharged. In this case, since the binding liquid discharged to the powder layer reaches the previously formed cross-sectional member, the newly formed cross-sectional member is bound to the previously formed cross-sectional member. These processes are repeated to sequentially laminate the thin cross-sectional members, thereby forming a three-dimensional object.

In the three-dimensional molding technique, it is possible to bind powder to mold a three-dimensional object as long as three-dimensional shape data of the object is prepared in advance. Since it is not necessary to make a mold before molding, it is possible to rapidly mold a three-dimensional object at a low cost. In addition, since thin flat cross-sectional members are sequentially formed and laminated, it is possible to integrally form an object having a complicated internal structure without separately forming a plurality of parts.

Further, a technique has been proposed which uses different kinds of powder for regions when forming a powder layer, thereby allowing integral molding of an object (JP-A-2002-307562). In this case, the object seems to be formed by assembling a plurality of parts made of different kinds of materials.

However, even though different kinds of powder are used for regions to form the powder layer, it is difficult to prevent different types of powder from becoming mixed with each other at the boundaries between the regions. Therefore, it is difficult to form an object having a fine internal structure with a certain physical property or an object having very precise parts with a certain physical property.

### SUMMARY

An advantage of some aspects of the invention is that it provides a three-dimensional molding technique capable of integrally forming an object having a fine internal structure with a certain physical property or an object having very precise parts with a certain physical property.

According to an aspect of the invention, there is provided a three-dimensional molding apparatus for binding powder with a binding liquid to mold a three-dimensional object The apparatus includes a shape data storage unit that stores shape data of the three-dimensional object including a region having a desired physical property; a cross-section data generating unit that, when the three-dimensional object is cut Into a plurality of cross-sectional layers, generates cross-section data for each of the layers; a cross-sectional member forming unit that spreads the powder with a substantially uniform thickness to form a powder layer, and supplies the binding liquid to the powder layer on the basis of the cross-section data to form a cross-sectional member corresponding to one layer of the three-dimensional object; and a three-dimensional object molding unit that forms a new powder layer on the powder layer in which the cross-sectional member is formed, supplies the binding liquid to the new powder layer on the basis of the cross-section data to form a new cross-sectional member, and laminates the new cross-sectional member on the previous cross-sectional member, thereby forming the three-dimensional object. The cross-sectional member forming unit can selectively supply a first binding liquid having the desired physical property or a second binding liquid not having the desired physical property. The cross-sectional member forming unit supplies the first binding liquid to a portion that is determined to be the region having the desired physical property on the basis of the cross-section data, and supplies the second binding liquid to the other portions, thereby forming the cross-sectional member.

According to another aspect of the invention, there is provided a method of binding powder with a binding liquid to mold a three-dimensional object. The method includes: storing shape data of the three-dimensional object including a region having a desired physical property; when the three-dimensional object is cut into a plurality of cross-sectional layers, generating cross-section data for each of the layers; spreading the powder with a substantially uniform thickness to form a powder layer, and supplying the binding liquid to the powder layer on the basis of the cross-section data to form a cross-sectional member corresponding to one layer of the three-dimensional object; and forming a new powder layer on the powder layer in which the cross-sectional member is formed, supplying the binding liquid to the new powder layer on the basis of the cross-section data to form a new cross-sectional member, and laminating the new cross-sectional member on the previous cross-sectional member, thereby forming the three-dimensional object. In the forming of the cross-sectional member, a first binding liquid having the desired physical property or a second binding liquid not having the desired physical property can be selectively supplied. The first binding liquid is supplied to a portion that is determined to be the region having the desired physical property on the basis of the cross-section data, and the second binding liquid is supplied to the other portions, thereby forming the cross-sectional member.

In the three-dimensional molding apparatus and the three-dimensional molding method according to the above-mentioned aspects of the invention, shape data of a three-dimensional object to be molded is stored beforehand, and, when the three-dimensional object is cut into a plurality of cross-sectional layers, it is possible to generate cross-section data for each of the layers. In addition, powder is spread with a uniform thickness to form a powder layer, and a binding liquid is supplied to the powder layer on the basis of the cross-section data. When the binding liquid is supplied to the powder layer, powder particles are bound to each other. Therefore, it is possible to form a three-dimensional cross-sectional member (cross-sectional member) having a thickness corresponding to the thickness of the powder layer by supplying the binding liquid on the basis of the cross-section data. Then, a new powder layer is formed on the powder layer in which the cross-sectional member is formed, and a binding liquid is supplied to the new powder layer on the basis of the cross-section data, thereby forming a new cross-sectional member so as to be laminated on the previously formed cross-sectional member. These processes are repeated to mold a three-dimensional object. In this case, when a cross-sectional member is formed, a first binding liquid having a desired physical property or a second binding liquid not having the desired physical property is selectively supplied to the powder layer to form the cross-sectional member. The first binding liquid is supplied to a portion that is determined to be a region having a desired physical property, and the second binding liquid is supplied to the other regions, on the basis of the cross-section data, thereby forming the cross-sectional member. For example, when the desired physical property is conductivity, the term ‘not having a desired physical property’ means ‘not having conductivity’. When the desired physical property is ‘conductivity within a predetermined range’, the term ‘not having a desired physical property’ means ‘not having a numerical value indicating conductivity within the predetermined range’.

Even when different kinds of powder are used to form a powder layer such that a portion of a three-dimensional object has a desired physical property, it is difficult to clearly define the boundary between the regions since powder particles are mixed with each other at the boundary. Therefore, in the three-dimensional object formed of a certain kind of powder, it is difficult to form a minute member with a different kind of powder (that is, powder having a different physical property), or it is difficult to form members at exact positions with different kinds of powder. In contrast, since a binding liquid can be supplied to the exact position of the powder layer, it is easy to supply different kinds of binding liquids to the boundary between the regions, and it is possible to supply a different kind of binding liquid to a specific portion of the three-dimensional object. Therefore, it is possible to form a cross-sectional member by supplying the first binding liquid having a desired physical property to a portion that is determined to be a region having the desired physical property and supplying the second binding liquid not having the desired physical property to the other portions, on the basis of cross-section data. As a result, it is possible to integrally form an object having a fine internal structure with a desired physical property or an object having a very precise portion with a desired physical property.

In the three-dimensional molding apparatus according to the above-mentioned aspect, preferably, the first conductive binding liquid or the second non-conductive binding liquid is selectively supplied to the powder layer, thereby forming the cross-sectional member.

According to the above-mentioned structure, it is possible to form a three-dimensional object in which only a portion thereof to which the first binding liquid is supplied has conductivity. Therefore, it's possible to integrally form a three-dimensional object having a complicated electrical circuit pattern.

### BRIEF DESCRIPTION OF THE DRAWINGS

FIG. 1 is a diagram illustrating the overall structure of a three-dimensional molding apparatus according to an embodiment of the invention.

FIGS. 2A and 2B are conceptual diagrams illustrating the operation of the three-dimensional molding apparatus molding a three-dimensional object.

FIG. 3 is a diagram illustrating an example of a circuit board that can be formed by the three-dimensional molding apparatus according to the embodiment of the invention.

FIG. 4 is a diagram illustrating a plurality of cross-sections taken from the circuit board having a complicated circuit formed therein.

FIGS. 5A to 5C are diagrams illustrating the operation of the three-dimensional molding apparatus according to the embodiment of the invention forming the circuit board.

FIG. 6 is a diagram illustrating an example of a three-dimensional object having rubber elasticity in a portion thereof.

FIG. 7 is a diagram illustrating an aspect in which a three-dimensional object is formed of materials having different thermal expansion coefficients and a portion of the three-dimensional object is deformed due to a variation in temperature.

### DESCRIPTION OF EXEMPLARY EMBODIMENTS

Hereinafter, exemplary embodiments of the invention will be described in the following order for clarity of the description of the invention:

A. Structure of apparatus;

B. Molding method of exemplary embodiments; and

C. Modifications

### A. Structure of Apparatus

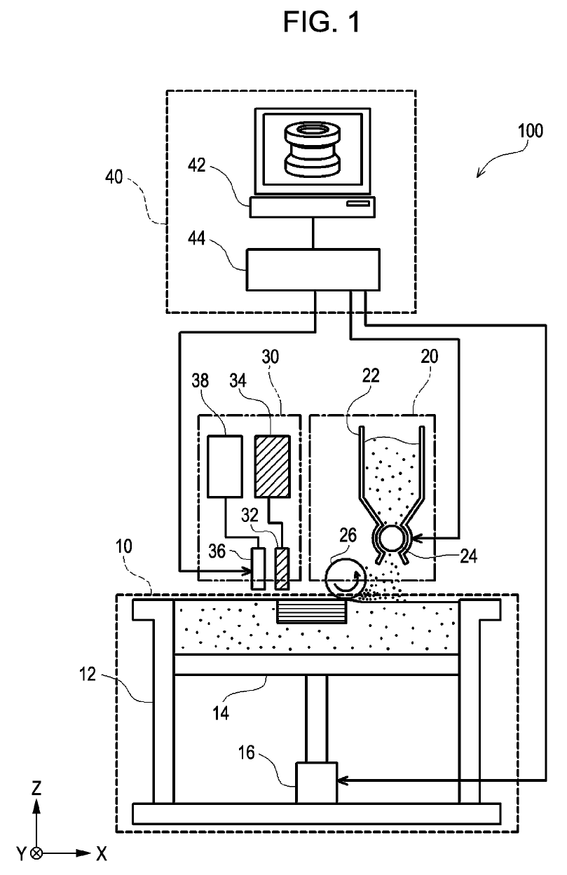

FIG. 1 is a diagram illustrating the overall structure of a three-dimensional molding apparatus 100 according to an embodiment of the invention. As shown in FIG. 1, the three-dimensional molding apparatus 100 includes a molding unit 10 that molds a three-dimensional object in a large frame, a powder layer forming unit 20 that forms a powder layer made of powder in the molding unit 10, a binding liquid supply unit 30 that supplies a binding liquid for binding powder particles to the powder layer, and an arithmetic unit 40 that performs various operations to control the overall operation of the three-dimensional molding apparatus 100.

The arithmetic unit 40 includes: a cross-section data generating unit 42 that stores shape data of a three-dimensional object to be molded, divides the three-dimensional object into a plurality of layers in sectional view, and generates cross-section data for each of the layers; and a control unit 44 that controls the operation of the molding unit 10, the powder layer forming unit 20, and the binding liquid supply unit 30 on the basis of the generated cross-section data. When receiving the cross-section data from the cross-section data generating unit 42, the control unit 44 drives the powder layer forming unit 20 to form a powder layer in the molding unit 10, and drives the binding liquid supply unit 30 to supply a binding liquid to the powder layer on the basis of the cross-section data. In this way, a thin plate member (cross-sectional member) having a cross-sectional shape that corresponds to cross-section data corresponding to one layer is formed in the molding unit 10. After the cross-sectional member corresponding to one layer is formed, the control unit drives a bottom driving unit 16 to slightly move a bottom unit 14 downward. Then, when the next cross-section data is received from the cross-section data generating unit 42, a new powder layer is formed on the powder layer in which the cross-sectional member is formed, and the binding liquid is supplied to the new powder layer to form a new cross sectional member. As such, when receiving cross-section data for each layer from the cross-section data generating unit 42, the control unit 44 drives the molding unit 10, the powder layer forming unit 20, and the binding liquid supply unit 30 to form cross-sectional members one by one, thereby forming a laminate of the cross-sectional members.

The cross-section data generating unit 42 may be composed of a known computer including a CPU, a ROM, a RAM, and a hard disk provided therein so as to exchange data therebetween. The control unit 44 may be composed of a dedicated IC chip that converts cross-section data into driving signals for the molding unit 10, the powder layer forming unit 20, and the binding liquid supply unit 30. Of course, the CPU, the ROM, and the RAM may be used to perform this conversion process. In this case, the function of the control unit 44 may be incorporated into the computer forming the cross-section data generating unit 42, such that the control unit 44 and the cross-section data generating unit 42 are integrated with each other.

The molding unit 10 includes a frame 12 having a rectangular shape in plan view, a bottom portion 14 that forms the bottom of the frame 12 and is movable in the vertical direction, and a bottom driving unit 16 that moves the bottom portion 14 in the vertical direction. A three-dimensional object is molded in a space between the frame 12 and the bottom portion 14. The bottom driving unit 16 is controlled by the control unit 44 to accurately move the bottom portion 14 in the vertical direction.

The powder layer forming unit 20 includes a hopper 22 that contains powder, a powder supply roller 24 that is provided at a lower part of the hopper 22 and is rotated to supply a predetermined amount of powder, and an extension roller 26 that spreads the powder supplied from the powder supply roller 24 so as to have a predetermined thickness to form a powder layer. For example, various kinds of powder, such as resin powder, metal powder, and oxide powder, may be used as the powder, and an appropriate kind of powder is selected according to the physical properties of a three-dimensional object to be molded. The hopper 22, the powder supply roller 24, and the extension roller 26 are formed so as to extend in a direction (Y direction) orthogonal to the plane of FIG. 1, and the entire structure of the powder layer forming unit 20 is configured so as to be movable in the horizontal direction (X direction) in the plane of FIG. 1.

In order to form a powder layer, first, the powder layer forming unit 20 is moved to the left end of FIG. 1. In this case, the bottom driving unit 16 is driven to move the bottom portion 14 downward (in the negative Y direction) by a distance corresponding to the thickness of a powder layer to be formed. Then, the powder supply roller 24 is rotated to move the powder layer forming unit 20 to the right direction (in the positive X direction) while supplying powder in front of the extension roller 26. The extension roller 26 is rotated in the direction opposite to the traveling direction. Then, the extension roller 26 is moved while spreading surplus powder in the traveling direction. As a result, a powder layer with a uniform thickness is formed at the rear side of the extension roller. In this case, the supply speed of powder is appropriately controlled according to the thickness of a powder layer to be formed and the traveling speed of the powder layer forming unit 20. In addition, the rotational speed of the extension roller 26 is appropriately controlled according to the traveling speed of the powder layer forming unit 20. In this way, it is possible to spread surplus powder in the traveling direction to extend a constant amount of powder all the time. As a result, it is possible to prevent an excessively large amount of powder from being spread.

The binding liquid supply unit 30 includes two sets of a supply head that supplies the binding liquid to the powder layer and a container that contains the binding liquid. A first binding liquid supply head 32 supplies a first binding liquid contained in a first binding liquid container 34 to the powder layer, and a second binding liquid supply head 36 supplies a second binding liquid contained in a second binding liquid container 38 to the powder layer.

In this embodiment, so-called piezoelectric liquid droplet discharge heads are used as the two binding liquid supply heads 32 and 36. In the piezoelectric liquid droplet discharge head, a pressure chamber provided with fine nozzles is filled up with liquid, and a piezoelectric element is used to bend the side wall of the pressure chamber to reduce the volume of the pressure chamber, thereby discharging the amount of liquid corresponding to the reduction in volume as liquid droplets. In the binding liquid supply unit 30 according to this embodiment, the first binding liquid contained in the first binding liquid container 34 is supplied to the pressure chamber of the first binding liquid supply head 32, and the piezoelectric element is driven to discharge the first binding liquid as liquid droplets. Similarly, the second binding liquid contained in the second binding liquid container 38 is supplied to the pressure chamber of the second binding liquid supply head 36, and the piezoelectric element is driven to discharge the second binding liquid as liquid droplets.

For example, a liquid resin material having monomers and oligomer consisting of monomers as a main ingredient is used as the binding liquid. In addition, a monomer having a relatively low molecular weight is selected as the monomer of the binding liquid and the number of monomers contained in one oligomer is adjusted such that the binding liquid has sufficiently low viscosity to be discharged from the piezoelectric liquid droplet discharge head as liquid droplets. Since only the binding liquid is stable, the binding liquid can be discharged as liquid droplets without becoming hardened in the binding liquid containers 34 and 38 or the binding liquid supply heads 32 and 36. However, when the binding liquid contacts a polymerization initiator, the monomers are polymerized into an oligomer, and the oligomers are polymerized. As a result, the binding liquid is relatively rapidly hardened to a solid material. In the three-dimensional molding apparatus 100 according to this embodiment, the surface of powder is coated with the polymerization initiator. Therefore, when liquid droplets of the binding liquid are supplied to the powder layer, the binding liquid infiltrates into the powder layer and then contacted with the polymerization initiator coated on the surface of powder to be rapidly hardened. As a result, powder particles are bound to each other by the hardened binding liquid in a portion of the powder layer onto which the binding liquid is discharged.

The binding liquid supply unit 30 can be moved in the X direction (the horizontal direction in the plane of FIG. 1) and the Y direction (the vertical direction in the plane of FIG. 1) independently from the powder layer forming unit 20, under the control of the control unit 44.

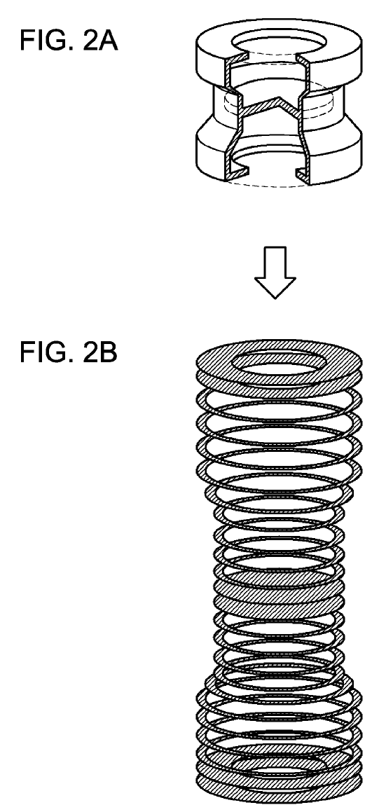

FIGS. 2A and 2B are conceptual diagrams illustrating a process of molding a three-dimensional object using the three-dimensional molding apparatus 100 having the above-mentioned structure according to this embodiment of the invention. It is necessary to store three-dimensional shape data of an object to be molded beforehand, in order to mold a three-dimensional object. FIG. 2A conceptually shows the shape data of a three-dimensional object to be molded. In the example shown in FIG. 2A, the three-dimensional object to be molded has an hourglass shape, and large windows are formed at the centers of the upper and lower surfaces of the hourglass-shaped object. In addition, a partition plate is provided inside the hourglass-shaped object to divide the inside space into an upper part and a lower part. When the three-dimensional object is cut into a plurality of cross-sectional layers parallel to the upper surface (or the lower surface), it is possible to obtain cross-section data shown in FIG. 2B. In this case, the cross-sections are not necessarily taken at equal intervals. However, in this embodiment, the cross-sections are taken at equal intervals. In addition, this process is performed by the cross-section data generating unit 42, and the obtained cross-section data is supplied to the control unit 44

The control unit 44 drives the molding unit 10 and the powder layer forming unit 20 to form a powder layer, and drives the binding liquid supply unit 30 on the basis of the cross-section data received from the cross-section data generating unit 42 to discharge a binding liquid to the powder layer. As described above, piezoelectric liquid droplet discharge heads are used as both the binding liquid supply heads 32 and 36 discharging the binding liquid, and the control unit 44 controls the binding liquid supply heads 32 and 36 to be accurately positioned in the X and Y directions. Therefore, the binding liquid supply heads 32 and 36 can discharge the binding liquid to exact positions on the surface of the powder layer. As a result, it is possible to bind powder particles in a shape corresponding to the cross-section data, thereby forming a cross-sectional member. These processes are repeated to form a laminate of the cross-sectional members, thereby forming a three-dimensional object corresponding to three-dimensional shape data.

### B. Molding Method of this Embodiment

In this embodiment, since the three-dimensional molding apparatus 100 is provided with two sets of the binding liquid supply head and the binding liquid container, it can discharge two kinds of binding liquids. This structure makes it possible to integrally mold a three-dimensional object having a minute internal structure, such as a circuit pattern. Next, the molding method will be described in detail below.

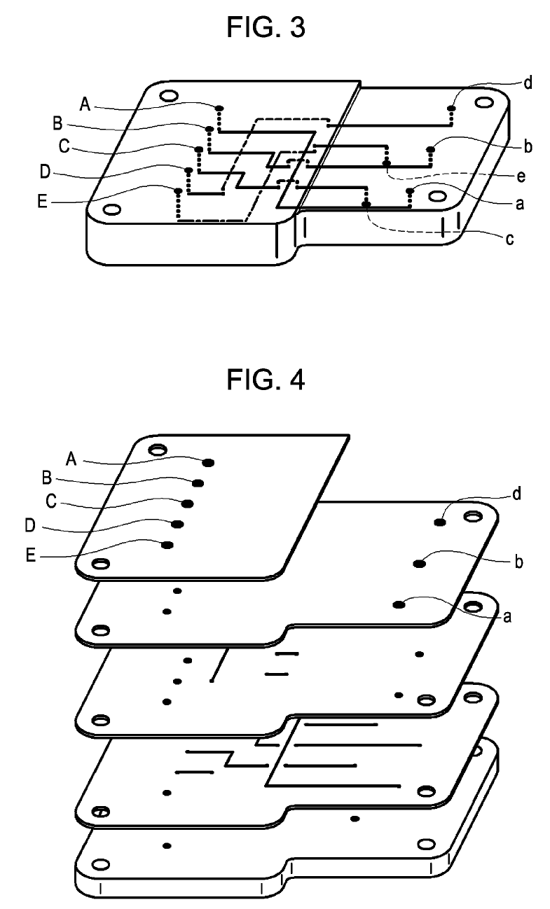

FIG. 3 is a diagram illustrating an example of a three-dimensional circuit board having a complicated circuit pattern formed therein. The circuit board shown in FIG. 3 is mainly divided into two parts, that is, left and right parts. Five terminals ‘A’ to ‘E’ are provided on the upper side of the left part. Three terminals ‘a’, ‘b’, and ‘d’ are provided on the upper side of the right part, and two terminals ‘c’, and ‘e’ are provided on the lower side of the right part. A three-dimensional circuit pattern is formed inside the circuit board such that the left terminals ‘A’ to ‘E’ are electrically connected to the right terminals ‘a’ to ‘e’, respectively. In FIG. 3, a circuit formed on the middle surface of the circuit board, as viewed in the thickness direction of the circuit board, is represented by bold solid lines. In addition, a circuit formed on the surface above the middle surface is represented by dashed lines, and a circuit formed on the surface below the middle surface is represented by one-dot chain lines. Further, a circuit extending in the depth direction is represented by dotted lines. As described above, it is possible to form a circuit board in which the left terminals ‘A’ to ‘E’ are electrically connected to the right terminals ‘a’ to ‘e’, respectively, by forming a three-dimensional circuit in the circuit board.

When the three-dimensional molding apparatus 100 is used to form such a circuit board, first, three-dimensional shape data of the circuit board is generated, and cross-section data for a plurality of cross-sectional layers of the circuit board is generated. FIG. 4 is a diagram illustrating a plurality of cross-sections taken from the circuit board. FIG. 4 shows only some of the cross-sections for clarity of illustration.

As shown in FIG. 4, when cross-sectional members having circuits formed at the exact positions on the cross-sections taken from the circuit board are molded, it is possible to obtain a circuit board having complicated circuits three-dimensionally formed therein by laminating the cross-sectional members. However, as shown in FIG. 4, it is difficult to form the cross-sectional members having a fine structure, such as a circuit pattern, using different kinds of powder. That is, when a board is formed of insulating powder and circuits are formed of conductive powder, the different kinds of powder are mixed with each other at the boundary therebetween, which makes it difficult to form the circuits at exact positions. For this reason, in this embodiment, the three-dimensional molding apparatus 100 discharges two different kinds of binding liquids to form a circuit board according to the following method.

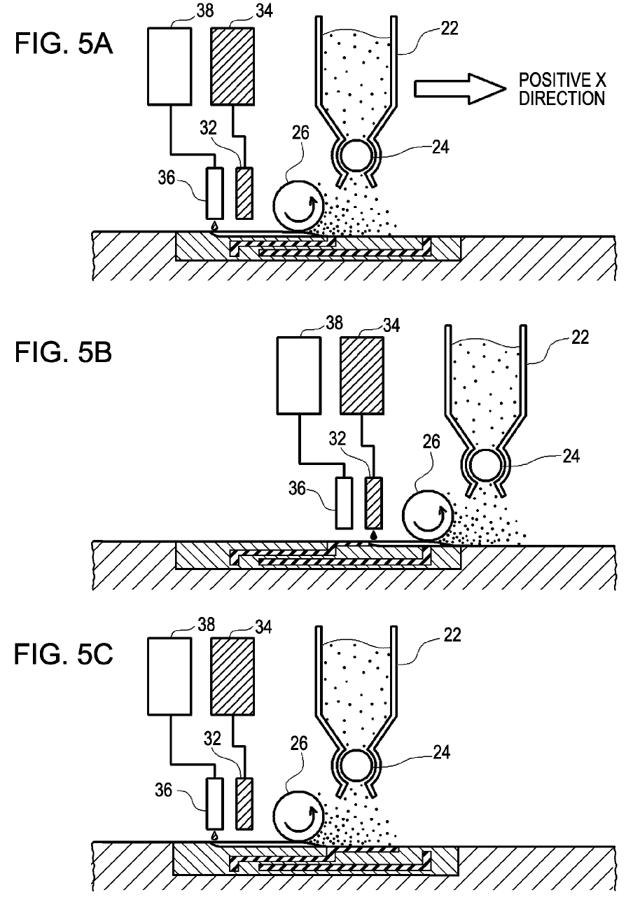

FIGS. 5A to 5C are diagrams illustrating the operation of the three-dimensional molding apparatus 100 forming a circuit board. In order to form a circuit board, the powder layer forming unit 20 is moved from the left side to the right side in the plane of FIGS. 5A to 5C (in the positive X direction) to form a powder layer. Then, the second binding liquid supply head 36 discharges the second binding liquid to a portion corresponding to a board (a portion in which no circuit is formed) to bind powder particles. In the three-dimensional molding apparatus 100 according to this embodiment, since both the powder and the second binding liquid are formed of an insulating material, the second binding liquid is discharged to form an insulating board. FIG. 5A shows a process of discharging the second binding liquid to the powder layer to form the board.

Further, the first binding liquid is discharged to bind powder particles, thereby forming circuits. In the three-dimensional molding apparatus 100 according to this embodiment, a binding liquid that has conductivity when being polymerized is used as the first binding liquid. Therefore, when the first binding liquid is discharged to bind powder particles, it is possible to form a portion having conductivity. As the first binding liquid, liquids including conductive resin or pigment can be used, which are disclosed in, for example, JP-A-2007-119548, JP-A-2007-31372, JP-A-2007-119682, and JP-A-2007-100062. When the first binding liquid is discharged to powder, a conductive layer is formed. Therefore, it is possible to form a circuit pattern by discharging the first binding liquid. In addition, it is possible to easily determine a conductive portion, that is, a portion forming a circuit, on the basis of cross-section data. FIG. 5B shows a process of discharging the first binding liquid to the powder layer, thereby forming a circuit.

In this way, the first conductive binding liquid is discharged to a portion corresponding to a circuit pattern, and the second non-conductive binding liquid is discharged to another portion corresponding to a board according to the cross-section data, thereby forming a cross-sectional member corresponding to one layer. Then, a powder layer is formed on the cross-sectional member. Then, the first conductive binding liquid is discharged to a portion of the powder layer corresponding to a circuit pattern, and the second non-conductive binding liquid is discharged to another portion of the powder layer corresponding to a board according to the cross-section data, thereby forming another cross-sectional member. FIG. 5C shows a process of forming a new powder layer on the cross-sectional member and discharging the first binding liquid or the second binding liquid to form another cross-sectional member.

In this way, when cross-sectional members corresponding to all cross-section data are completely laminated, a molded object is taken out from the laminate of the powder layers formed in the molding unit 10. Then, the powder particles that are not bound by the binding liquid are separated, and the three-dimensional object shown in FIG. 3 is obtained. The powder particles are bound to each other by a conductive resin to form a conductive circuit in the portion to which the first binding liquid is discharged. Of course, it is possible to bind conductive powder particles to only partially form a conductive portion. However, in a fine structure, such as a circuit pattern, it is difficult to form a powder layer such that only a circuit pattern is formed of conductive powder particles. In contrast, the use of the binding liquid makes it possible to discharge an exact amount of liquid droplets to exact positions on the powder layer. Therefore, it is possible to discharge the first conductive binding liquid to only a portion corresponding to a circuit pattern and the second non-conductive binding liquid to another portion corresponding to a board, thereby binding powder particles, even in a fine structure such as a circuit. As a result, it is possible to integrally form the circuit board shown in FIG. 3 having a complicated three-dimensional circuit formed therein.

### C. Modifications

Various modifications of the three-dimensional molding apparatus 100 according to the above-described embodiment can be made. Next, the modifications will be briefly described.

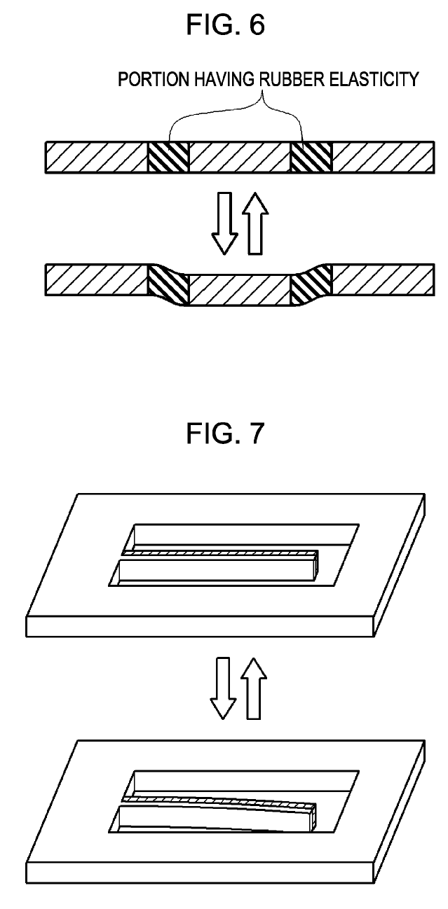

In the above-described embodiment, the conductive binding liquid is discharged to powder particles such that a portion of the three-dimensional object has conductivity, thereby forming a circuit board. However, the invention is not limited thereto, but binding liquids having various physical properties other than conductivity may be used. For example, a liquid that contains monomers of room temperature setting silicon rubber, which is called RTV silicon rubber, dispersed or dissolved therein may be used as the first binding liquid. In this case, only a portion to which the first binding liquid is discharged can have rubber elasticity. As a result, as shown in FIG. 6, it is possible to form a three-dimensional object that can be partially bent, is soundproof, dustproof, and impact resistant, and has a high repulsive portion.

Further, binding liquids having different thermal expansion coefficients may be used. In this case, it is possible to form a three-dimensional object that is deformable depending on the temperature. For example, as shown in FIG. 7, when a flat three-dimensional object is formed by discharging a binding liquid having a high thermal expansion coefficient to a dashed portion and a binding liquid having a low thermal expansion coefficient to the other portions, the flat three-dimensional object can be deformed due to a variation in the temperature.

Further, a binding liquid having as main ingredients monomers or polymers forming a hydrophilic urethane resin or polyvinyl acetate resin may be used as the first binding liquid. In this case, when binding liquids are discharged to form a three-dimensional object, a portion thereof to which the first binding liquid is discharged can be easily adhered to metal or glass. Alternatively, since only the portion to which the first binding liquid is discharged has a high hydrophilic property, it is possible to integrally form a structure for holding bacteria such as a bioreactor.

Furthermore, a binding liquid having as main ingredients monomers or polymers forming a silicon resin may be used as the first binding liquid. In this case, it is possible to form a portion having air permeability by discharging the first binding liquid. Therefore, it is possible to form an airtight container having an air-permeable wall that is used to grow living organisms, or it is possible to form a container that can be deaerated due to the difference between the internal and external pressures thereof.

Further, a binding liquid having as main ingredients monomers or polymers of a resin having a relatively low melting point or glass transition point may be used as the first binding liquid. In this case, at the melting point or the glass transition point, the portion formed by discharging the first binding liquid is dissolved or softened. Therefore, it is possible to form a safety device that prevents an increase in temperature above the melting point or the glass transition point.

Although the three-dimensional molding apparatus 100 according to the embodiments of the invention has been described above, the invention is not limited thereto, but various modifications and changes of the invention can be made without departing from the scope and spirit of the invention.

For example, in the above-described embodiment, the three-dimensional molding apparatus 100 is provided with two kinds of binding liquids, that is, the first binding liquid and the second binding liquid. However, the kind of binding liquids is not limited two, but three or more kinds of binding liquids may be provided in the three-dimensional molding apparatus. In this case, it is possible to form a three-dimensional object having physical properties corresponding to the kinds of binding liquids discharged, by discharging the binding liquids to bind powder particles.

What is claimed is:

1. A three-dimensional molding apparatus for binding powder with a binding liquid to mold a three-dimensional object, the apparatus comprising:
a shape data storage unit that stores shape data of the three-dimensional object including a region having a desired physical property;
a cross-section data generating unit that, when the three-dimensional object is cut into a plurality of cross-sectional layers, generates cross-section data for each of the layers;
a cross-sectional member forming unit that spreads the powder so as to have a substantially uniform thickness to form a powder layer, and supplies the binding liquid to the powder layer on the basis of the cross-section data to form a cross-sectional member corresponding to one layer of the three-dimensional object; and
a three-dimensional object molding unit that forms a new powder layer on the powder layer in which the cross-sectional member is formed, supplies the binding liquid to the new powder layer on the basis of the cross-section data to form a new cross-sectional member, and laminates the new cross-sectional member on the previous cross-sectional member, thereby forming the three-dimensional objects
wherein the cross-sectional member forming unit can selectively supply a first binding liquid having the desired physical property or a second binding liquid not having the desired physical property, and
the cross-sectional member forming unit supplies the first binding liquid to a portion that is determined to be the region having the desired physical property on the basis of the cross-section data, and supplies the second binding liquid to the other portions, thereby forming the cross-sectional member.

2. The three-dimensional molding apparatus according to claim 1,
wherein the cross-sectional member forming unit selectively supplies the first conductive binding liquid or the second non-conductive binding liquid to the powder layer, thereby forming the cross-sectional member.

3. The three-dimensional molding apparatus according to claim 2,
wherein the first conductive binding liquid includes a monomer or a polymer composed of high conductivity molecules.

4. The three-dimensional molding apparatus according to claim 1,
wherein the first binding liquid includes a silicon-based polymer or monomer.

5. The three-dimensional molding apparatus according to claim 1,
wherein the first binding liquid includes a hydrophilic polymer or monomer.

6. The three-dimensional molding apparatus according to claim 1,
wherein a glass transition point of a resin formed by hardening the first binding liquid is different from that of a resin formed by hardening the second binding liquid.

7. A method of binding powder with a binding liquid to mold a three-dimensional object, the method comprising:
storing shape data of the three-dimensional object including a region having a desired physical property;
when the three-dimensional object is cut into a plurality of cross-sectional layers, generating cross-section data for each of the layers;
spreading the powder with a substantially uniform thickness to form a powder layer, and supplying the binding liquid to the powder layer on the basis of the cross-section data to form a cross-sectional member corresponding to one layer of the three-dimensional object; and
forming a new powder layer on the powder layer in which the cross-sectional member is formed, supplying the binding liquid to the new powder layer on the basis of the cross-section data to form a new cross-sectional member, and laminating the new cross-sectional member on the previous cross-sectional member, thereby forming the three-dimensional object,
wherein, in the forming of the cross-sectional member, a first binding liquid having the desired physical property or a second binding liquid not having the desired physical property can be selectively supplied, and
the first binding liquid is supplied to a portion that is determined to be the region having the desired physical property on the basis of the cross-section data, and the second binding liquid is supplied to the other portions, thereby forming the cross-sectional member.
